(19) United States
(12) Patent Application Publication
(10) Pub. No.: US 2024/0324815 A1
(43) Pub. Date: Oct. 3, 2024

(54) BBQ GRILL HOOD FOR ALLOWING ONE TO BAKE WITH THE BBQ GRILL, AND RELATED SYSTEMS AND METHODS

(71) Applicant: Richard Peterson, Chelan, WA (US)

(72) Inventor: Richard Peterson, Chelan, WA (US)

(21) Appl. No.: 17/757,288

(22) PCT Filed: Jan. 26, 2022
(86) PCT No.: PCT/US22/13879

§ 371 Date: May 22, 2024

Related U.S. Application Data
(60) Provisional application No. 63/172,436, filed on Apr. 8, 2021.

(51) Int. Cl. A47J 37/07; A47J 37/06

(52) U.S. Cl. CPC A47J 37/0713; A47J 37/0658; A47J 37/0709

(57) ABSTRACT

A hood for facilitating the use of a BBQ-grill system to bake a pizza, includes a body, and a door. The body is moveable relative to a cooking surface of a BBQ-grill system to a first position in which the body covers the cooking surface, and to a second position in which the body exposes the cooking surface of the BBQ-grill system to the ambient environment. The hood's body has a portal sized to allow a pizza to pass through, and is configured such that when the body is in the first position, the body and the BBQ's cooking surface, together, define an enclosure in which heat that is generated by the BBQ-grill system is trapped. The hood's door is coupled with the body and moveable relative to the body to a first position that closes the portal, and to a second position that opens the portal. When the hood's body is in the first position and the door is in the second position, a pizza may be inserted into the volume defined by the body and the cooking surface without a substantial loss of heat inside the volume.

### CROSS-REFERENCE TO RELATED APPLICATIONS AND INCORPORATION BY REFERENCE

This application claims priority from U.S. Provisional Patent Application 63/172,436 filed 8 Apr. 2021 and titled “Piehole, and Related Systems and Methods”. This application also incorporates by this reference the entirety of U.S. Provisional Patent Application 63/172,436.

### BACKGROUND

Many people prefer to prepare and cook pizza at home because preparing a pizza is easy to do and when done at home one can use and include any desired ingredients in any desired amount to obtain a specific pizza not commonly available at a conventional pizzeria. Unfortunately, most conventional ovens are not designed to provide the high temperatures needed to cook a pizza well. Most pizza ovens cook pizza between 800 and 900 degrees Fahrenheit; while most conventional ovens found in homes can achieve a maximum temperature of around 500 degrees. Although pizza can be adequately cooked at 500 degrees, the hotter the temperature in the oven, the better the pizza will be when finished.

To overcome this problem, many people cook pizza on an outdoor charcoal or gas grill. The outdoor grill is capable of achieving temperatures around 600 to 700 degrees Fahrenheit—depending on the fuel used (gas or charcoal).

Unfortunately, however, cooking pizza on one's outdoor grill poses problems. Every time one opens the lid to the grill to place a pizza on the grill or to check on the cooking progress of the pizza, one let's a substantial amount of heat escape out of the oven box created between the grill and lid. This causes the temperature inside the oven box to fluctuate between large extremes, which in turn causes the pizza to cook unevenly over time. This uneven cooking over time causes the pizza to cook as if it were in a conventional oven that typically maxes out at around 500 degrees Fahrenheit, thus losing any advantage in greater heat provided by the outdoor grill.

To overcome this, many people use a pizza oven located outside that is capable of generating the high temperatures desired for cooking pizza. The additional oven dedicated to just pizzas, however, can be expensive and take up space on one's deck or yard that could otherwise be used for other entertainment.

Thus, there is a need for an outdoor grill that can cook pizzas well and also be used as a conventional outdoor grill to cook meats.

### SUMMARY

In one aspect of the invention, a hood for facilitating the use of a BBQ grill to bake a pizza, includes a body, and a door. The body is moveable relative to a cooking surface of a BBQ grill to a first position in which the body covers the cooking surface, and to a second position in which the body exposes the cooking surface of the BBQ grill to the ambient environment. The hood's body has a portal sized to allow a pizza to pass through, and is configured such that when the body is in the first position, the body and the BBQ grill's cooking surface, together, define an enclosure in which heat that is generated by the BBQ grill is trapped. The hood's door is coupled with the body and moveable relative to the body to a first position that closes the portal, and to a second position that opens the portal. When the hood's body is in the first position and the door is in the second position, a pizza may be inserted into the volume defined by the body and the cooking surface without a substantial loss of heat inside the volume.

With the ability to access the volume between the hood and the cooking surface that the hood covers without having to move the whole hood relative to the cooking surface, one can insert and withdraw a pizza from the volume between the hood and the cooking surface without losing a substantial amount of heat. This allows the high temperature established inside an outdoor grill to remain while one cooks and checks on a pizza that the outdoor grill is cooking. And with the ability to move the whole hood to the second position (opened), one can easily access the cooking surface to grill meats and vegetables in a conventional manner. Thus, the hood 12 facilitates the dual use of the BBQ grill to effectively and efficiently bake a pizza, and effectively and efficiently grill meats and vegetables.

In another aspect of the invention, a method for baking a pizza on a BBQ grill includes: 1) moving to a first position a hood of a BBQ grill relative to a cooking surface of the BBQ grill, wherein in the first position the body covers the cooking surface; 2) trapping heat in an enclosure that is defined by the volume between the hood and the BBQ grill's cooking surface; 3) moving a door to a first position to open a portal of the hood, the door being coupled with the hood, and the portal being sized and configured to allow a pizza to pass through the body and into the enclosure; 4) inserting a pizza through the portal into the enclosure without moving the hood to a different position; and 5) moving the door to a second position to close the portal.

In yet another aspect of the invention a BBQ-grill system includes a housing, a heating element disposed inside the housing and operable to generate heat; a cooking surface adjacent the heating element and operable to hold near the heating element an item to be cooked; and a hood. The hood includes a body and a door. The body is moveable relative to the cooking surface to a first position in which the body covers the cooking surface, and to a second position in which the body exposes the cooking surface to the ambient environment. The hood's body has a portal sized to allow a pizza to pass through it, and is configured such that when the body is in the first position, the body and the cooking surface, together, define an enclosure in which heat that is generated by the heating element is trapped. The hood's door is coupled with the body and moveable relative to the body to a first position that closes the portal, and to a second position that opens the portal, such that when the body is in the first position and the door is in the second position, a pizza may be inserted into the enclosure without a substantial loss of heat inside the enclosure.

### BRIEF DESCRIPTION OF THE DRAWINGS

FIG. 1 shows a perspective view of a BBQ-grill system that includes a hood, according to an embodiment of the invention.

FIG. 2 shows a cross-sectional view of a portion of the BBQ-grill system shown in FIG. 1, according to an embodiment of the invention.

FIG. 3 shows a perspective view of a portion of the hood of the BBQ-grill system shown in FIG. 1, according to an embodiment of the invention.

FIG. 4 shows a perspective view of the hood shown in FIGS. 1-3, according to an embodiment of the invention.

FIG. 5 shows a perspective view of a BBQ-grill system's hood, according to another embodiment of the invention.

FIG. 6 shows a perspective view of a BBQ-grill system's hood, according to another embodiment of the invention.

FIG. 7 shows a perspective view of a BBQ-grill system's hood, according to yet another embodiment of the invention.

### DETAILED DESCRIPTION

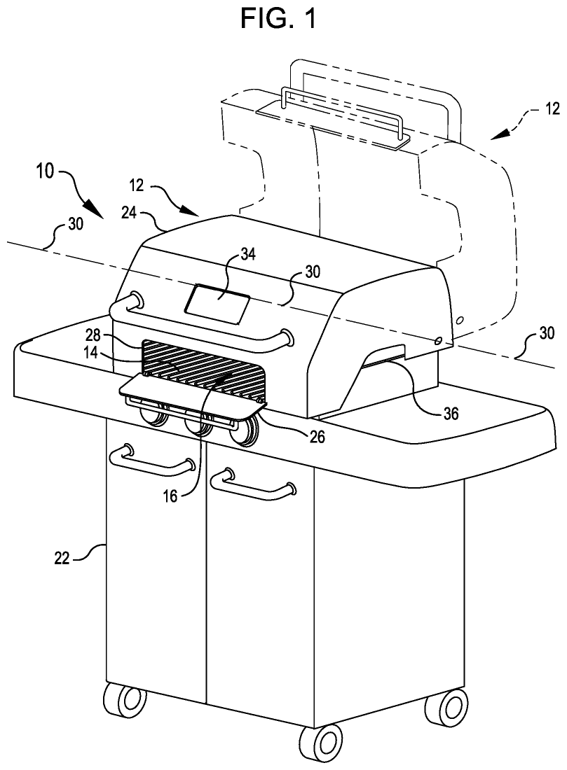

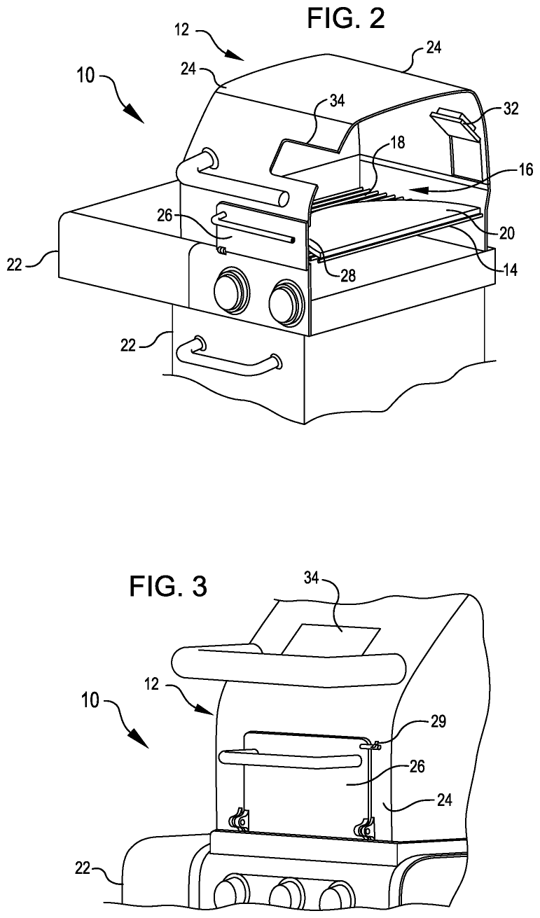

Each of FIGS. 1-3 shows a view of a BBQ-grill system 10 that includes a hood 12, according to an embodiment of the invention. FIG. 1 shows a perspective view of the system 10 and hood 12. FIG. 2 shows a cross-sectional view of a portion of the BBQ-grill system 10 and hood 12. And FIG. 3 shows a close-up, perspective view of a portion of the hood 12 and system 10. The BBQ-grill system 10 includes a cooking surface 14, and an enclosure 16 having a volume defined by the space between the cooking surface 14 and the hood 12. The cooking surface 14 includes a grill 18 for grilling meats, and a removeable pizza stone 20 for cooking a pizza or other bread-type foods. The BBQ-grill system 10 also includes a housing 22 and a heating element (not shown) disposed in the housing 22 to generate heat to be trapped inside the enclosure 16. Here, the system 10 burns propane gas to generate heat; but other systems may burn natural gas, charcoal briquettes or wood to generate the heat used to cook food.

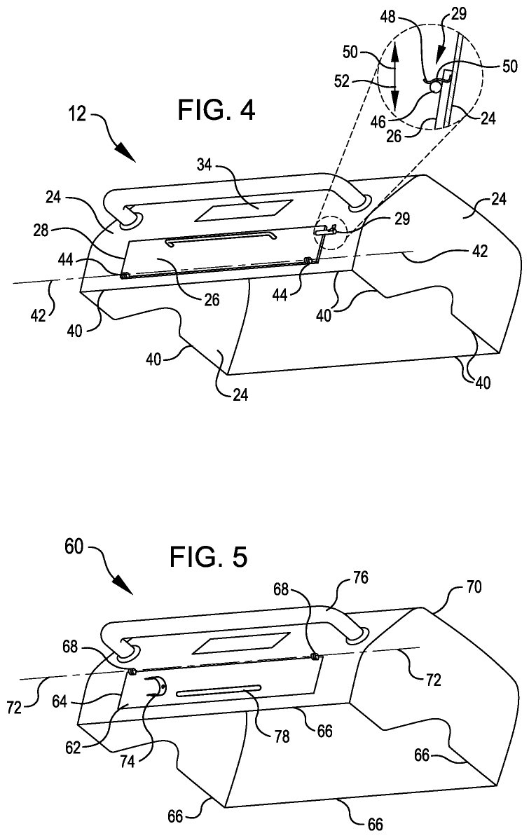

The hood 12 includes a body 24, and a door 26. The body 24 is moveable relative to the cooking surface 14 of the BBQ-grill system 10 to a first position (shown in FIG. 1 with solid lines, and in FIGS. 2 and 3), and a second position (shown in FIG. 1 with dashed lines). In the first position, the body 24 covers the cooking surface 14 to close the enclosure 16. In the second position, the body 24 exposes the cooking surface 14 to the ambient environment to open the enclosure 16. The body 24 is configured such that when the body 24 is in the first position (closed), the body 24 and the BBQ-grill system's cooking surface 14, together, define the enclosure 16 in which heat that is generated by the system's heating element is trapped. In addition, the hood's body 24 has a portal 28 sized to allow a pizza to pass through it. The hood's door 26 is coupled with the body 24 and moveable relative to the body 24 to a first position (shown in FIGS. 2 and 3) that closes the portal 28, and to a second position (shown in FIG. 1) that opens the portal 28. To lock the door 26 in the first position, the hood 12 includes a lock 29 (discussed in greater detail in conjunction with FIG. 4). When the hood's body 24 is in the first position (closed) and the door 26 is in the second position (opened), a pizza may be inserted into the volume of the enclosure 16.

With the ability to access the volume between the hood 12 and the cooking surface 14 that the hood 12 covers without having to move the whole hood 12 relative to the cooking surface 14, one can insert and withdraw a pizza into and from the volume of the enclosure 16 without losing a substantial amount of heat. This allows the high temperature established inside an outdoor grill to remain high while one cooks and checks on a pizza being cooked by the outdoor grill. And with the ability to move the whole hood 12 to the second position (opened), one can easily access the cooking surface 14 to use the BBQ-grill system 10 to grill meats and vegetables in a conventional manner. Thus, the hood 12 facilitates the dual use of the BBQ-grill system 10 to effectively and efficiently bake a pizza, and effectively and efficiently grill meats and vegetables.

Referring to FIG. 1, the hood 12 may be positioned in the first position (closed) in any desired manner, and moved to the second position (open) in any desired manner. For example, in this and other embodiments a hinge (not shown) couples the hood 12 with the BBQ-grill system's housing 22. In this configuration, the hood 12 pivots or rotates about a first axis 30 when being moved from the first position to the second position, and from the second position to the first position. In other embodiments, the hood may translate (as opposed to rotate) when the hood 12 is being moved from the first position to the second position, and vice-versa. In still other embodiments, the hood 12 may translate and rotate when the hood is moved from the first position to the second position, and vice-versa. Finally, the hood 12 may be coupled with other components of the BBQ-grill system 10, or not coupled at all. In such embodiments, the hood 12 is simply placed over the cooking surface 14 when the hood 12 is moved to the first position, and simply lifted off the cooking surface 14 when the hood 12 is moved to the second position; similar to the lid of a conventional Webber kettle grill.

Referring to FIG. 2, the BBQ-grill system 10 may include other components to facilitate cooking a pizza. For example, in this and other embodiments the BBQ-grill system 10 includes a light 32 positioned inside the enclosure 16 that can withstand the heat developed inside the enclosure 16. The BBQ-grill system 10 also includes a transparent window 34 located in a region of the hood 12 that is also capable of withstanding the heat developed inside the enclosure 16. With the light 32 illuminating the volume inside the enclosure, and the window 34 allowing light generated by the light 32 to be perceived outside of the enclosure 16, one can check the progress of the pizza cooking inside the enclosure without having to move the hood 12 to the second position (open). In addition, the BBQ-grill system 10 includes a rotisserie-hole cover 36 (here two, but only one shown in FIG. 1) to cover the hole in the hood 12 that allows one to use a rotisserie or rotating spit with the BBQ-grill system 10 to grill meats such as chicken and/or prime rib. When a rotisserie is not in use the hole into the enclosure 16 allows heat to escape from the enclosure 16 while the hood 12 is in the first position.

FIG. 4 shows a perspective view of the hood 12 shown in FIGS. 1-3, according to an embodiment of the invention. When the hood 12 is in the first position, the hood 12 traps inside the enclosure 16 heat generated by the BBQ-grill system's heating element to allow one to cook a pizza or roast meat.

The hood 12 may be configured as desired to accomplish this function. For example, in this and other embodiments the hood 12 includes a body 24 that is in the shape of a large bowl that is inverted to cover the cooking surface 14, not hold a liquid. The body 24 includes a perimeter 40 that is configured to contact the housing 22 of the BBQ-grill system 10 around the cooking surface 14. In this manner, when the hood 12 is in the first position, the hood 12 does not allow much heat to escape from inside the enclosure 16 through the interface between the housing 22 and the edge of the hood 12. The hood 12 also includes a portal 28 sized to allow a pizza to pass through it, and a door 26 coupled with the body 24 and moveable relative to the body 24 to the first position (shown in FIG. 4 and FIGS. 2 and 3) that closes the portal 28, and to the second position (shown in FIG. 1) that opens the portal 28. In this and other embodiments the portal 28 defines a portion of the body's perimeter 40. That is, the perimeter 40 of the hood 12 includes the whole edge of the portal 28, or in other words the body 24 does not include a region that extends from one side of the portal 28 straight across to the other side of the portal 28. Instead, the door 26 makes this direct connection between the two sides of the portal 28. In other embodiments, the hood 12 does include such a region that bridges the two sides of the portal 28, and that forms a portion of the hood's perimeter 40. In such embodiments, the portal 28 may be located near this region or may be located away from this region, depending on the location of the cooking surface 14 inside the enclosure 16.

Still referring to FIG. 4, the door 26 may be configured as desired to cover the portal 28 when in the first position (closed, shown in FIG. 4), and uncover the portal 28 when in the second position (open, shown in FIG. 1). For example, in this and other embodiments the door rotates about a second axis 42 that lies close to the perimeter of the hood's body 24 that is adjacent the portal 28 so that the door 26 lies below the portal 28 when the door 26 is in the second position (open). Each of the hinges 44 couples the door 26 with the hood's body 24 and allows the door 26 to rotate about the second axis 42. To lock the door 26 in the first position (closed), the hood 12 includes the lock 29.

The lock 29 may be configured as desired to hold the door 26 in the first position. For example, in this and other embodiments the lock 29 includes a bar 46 and a cantilevered latch 48. The cantilevered latch 48 is mounted to the body 24 of the hood 12, extends away from the body 24, and elastically bends when urged in either of the directions indicated by the arrows 50 and 52. With elastic deformation, the latch 48 will bend when enough force is applied in either of the directions indicated by the arrows 50 and 52, but will move back to the latch's original position before the force was applied, when the force is removed from the latch 48. The bar 46 is located on the door 26 such that when the door 26 is in the first position, the bar 46 nests within a region 50 of the latch 48 that, in the absence of a force great enough to elastically bend the latch 48 in the direction of the arrow 50, holds the bar 46, and thus prevents the door 26 from moving out of the first position. To position the door 26 in the first position, one pushes the door 26 toward the body 24 with enough force to cause the bar 46 to bend in the direction indicated by the arrow 50 until the bar 46 is under the region 50, and the latch 48 returns to its original position when the door was in the second position.

The hood's body 24 and door 26 may be made of any desired material capable of handling the heat developed in the enclosure 16. For example, in this and other embodiments, both the body 24 and door 26 are made of stainless steel. In other embodiments, the door 26 may be transparent to allow light generated inside the enclosure 16 to be perceived outside the enclosure 16. This may be desirable when the hood 12 does not include a window like the window 34 (shown in FIGS. 1-4). In still other embodiments the hood's body 24 may itself be transparent.

FIG. 5 shows a perspective view of a BBQ-grill system's hood 60, according to another embodiment of the invention. The hood 60 is similar to the hood 12 (FIGS. 1-4), except that the door 62 that covers the portal 64 swings up, away from the hood's perimeter 66, not down toward it. The hinges 68 couple the door 62 to the hood's body 70 and allow the door to rotate about the second axis 72. To releasably lock the door 64 in the second position (open), the hood 60 includes a lock 74 that clasps the hood's handle 76 pinching it between two opposed jaws that elastically bend similar to the latch 48 (FIG. 4). To rotate the door 62 about the second axis 72, one grabs and holds the handle 78 of the door 62.

Other embodiments are possible. For example, the lock 74 may include a piano-style hinge that holds/locks the door 62 in the second position when the door 40 is moved to the second position. This may be desirable when modifying an existing hood of a BBQ-grill system because the hood's handle 76 may be located anywhere on the hood and thus might not be available for use with the lock 74.

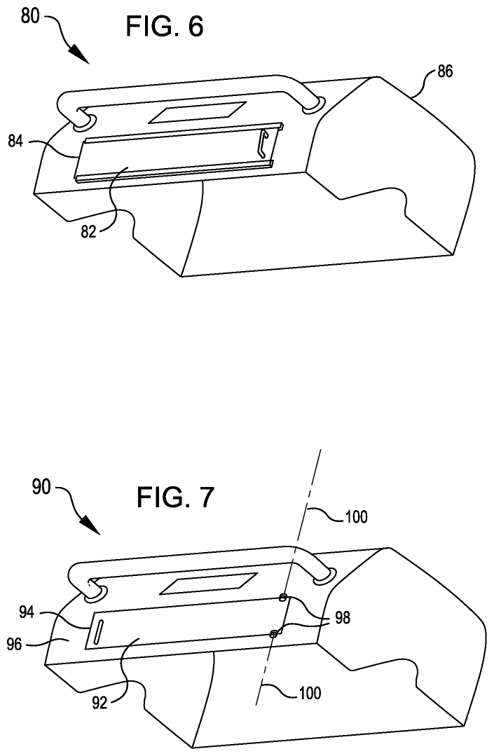

FIG. 6 shows a perspective view of a BBQ-grill system's hood 80, according to another embodiment of the invention. The hood 80 is similar to the hood 12 (FIGS. 1-4), except that the door 82 that covers the portal 84 slides relative to the hood's body 86 between the first and second positions.

FIG. 7 shows a perspective view of a BBQ grill system's hood 90, according to yet another embodiment of the invention. The hood 90 is similar to the hood 12 (FIGS. 1-4), except that the door 92 that covers the portal 94 swings out, away from the hood's body 96 about hinges 98 through which the second axis 100 extends. In other embodiments, the door 92 may have two halves each of which swings out, away from the hood's body 96 much like barn doors of a barn.

The preceding discussion is presented to enable a person skilled in the art to make and use the invention. Various modifications to the embodiments will be readily apparent to those skilled in the art, and the generic principles herein may be applied to other embodiments and applications without departing from the spirit and scope of the present invention. Thus, the present invention is not intended to be limited to the embodiments shown, but is to be accorded the widest scope consistent with the principles and features disclosed herein.

What is claimed is:

1. A hood for facilitating the use of a BBQ-grill system to bake a pizza, the hood comprising:
a body moveable relative to a cooking surface of a BBQ-grill system to:
a first position in which the body covers the cooking surface, and
a second position in which the body exposes the cooking surface of the BBQ-grill system to the ambient environment,
the body having a portal sized to allow a pizza to pass through, the body being configured such that when the body is in the first position, the body and the BBQ's cooking surface, together, define an enclosure in which heat that is generated by the BBQ is trapped;
a door coupled with the body and moveable relative to the body to a first position that closes the portal, and to a second position that opens the portal; and
wherein when the body is in the first position and the door is in the second position, a pizza may be inserted into the volume defined by the body and the cooking surface without a substantial loss of heat inside the volume.

2. The hood of claim 1 wherein the body includes a perimeter and is curved such that when the body is in the first position, the perimeter of the hood contacts the BBQ-grill system's cooking surface.

3. The hood of claim 1 wherein the body is coupled to a housing of the BBQ-grill system and rotates about an axis when the body is moved from the second position to the first position.

4. The hood of claim 1 wherein the body is configured such that when the body is in the first position, the body covers all of the BBQ-grill system's cooking surface.

5. The hood of claim 1 wherein the body is configured such that when the body is in the second position, the body does not cover any of the BBQ-grill system's cooking surface.

6. The hood of claim 1 wherein the body includes a perimeter and the portal defines a portion of the perimeter.

7. The hood of claim 1 wherein the body includes a perimeter and the portal is located near the perimeter.

8. The hood of claim 1 wherein the door slides relative to the body when moved to the first position and to the second position.

9. The hood of claim 1 wherein the door rotates about a second axis when moved to the first position and to the second position.

10. The hood of claim 1 wherein the door is transparent.

11. The hood of claim 1 further comprising a cover operable to cover a hole in the body that allows a rotisserie spit to extend through the body.

12. The hood of claim 1 further comprising a light operable to generate light in the enclosure when the hood is in the first position.

13. A method for baking a pizza with a BBQ-grill system, the method comprising:
moving to a first position a hood of a BBQ-grill system relative to a cooking surface of the BBQ-grill system, wherein in the first position the body covers the cooking surface;
trapping heat in an enclosure that is defined by the volume between the hood and the BBQ-grill system's cooking surface;
moving a door to a first position to open a portal of the hood, the door being coupled with the hood, and the portal being sized and configured to allow a pizza to pass through the body and into the enclosure;
inserting a pizza through the portal into the enclosure without moving the hood to a different position; and
moving the door to a second position to close the portal.

14. The method of claim 13 wherein the hood is coupled to a housing of the BBQ-grill system, and moving the hood to the first position includes rotating the hood about an axis.

15. The method of claim 13 wherein moving the door to the first position includes sliding the door relative to the hood.

16. The method of claim 13 wherein moving the door to the first position includes rotating the door about a second axis relative to the hood.

17. The method of claim 13 wherein moving the door to the second position includes sliding the door relative to the hood.

18. The method of claim 13 wherein moving the door to the second position includes rotating the door about a second axis relative to the hood.

19. The method of claim 13 further comprising locking the door in the first position.

20. The method of claim 13 further comprising locking the door in the second position.

21. The method of claim 13 further comprising generating light inside the enclosure to view the pizza baking.

22. The method of claim 13 further comprising covering a hole in the body that allows a rotisserie spit to extend through the body.

23. The method of claim 13 further comprising:
moving the door to the first position to open the portal again; and
withdrawing the pizza from the enclosure and through the portal without moving the hood to a different position.

24. A BBQ-grill system comprising:
a housing;
a heating element disposed inside the housing and operable to generate heat;
a cooking surface adjacent the heating element and operable to hold near the heating element an item to be cooked; and
a hood comprising:
a body moveable relative to the cooking surface to:
a first position in which the body covers the cooking surface, and
a second position in which the body exposes the cooking surface to the ambient environment,
the body having a portal sized to allow a pizza to pass through, the body being configured such that when the body is in the first position, the body and the cooking surface, together, define an enclosure in which heat that is generated by the heating element is trapped;
a door coupled with the body and moveable relative to the body to a first position that closes the portal, and to a second position that opens the portal; and
wherein when the body is in the first position and the door is in the second position, a pizza may be inserted into the enclosure without a substantial loss of heat inside the enclosure.

25. The system of claim 24 wherein the heating element generates heat via combustion of a gas.

26. The system of claim 24 wherein the heating element generates heat via electrical resistance.

27. The system of claim 24 wherein the cooking surface includes a grill.

28. The system of claim 24 wherein the cooking surface includes griddle.

29. The system of claim 24 wherein the cooking surface includes a pizza stone.
